(19) United States
(12) Patent Application Publication
(10) Pub. No.: US 2005/0138836 A1
(43) Pub. Date: Jun. 30, 2005

(54) Cabinet for home appliance

(76) Inventors: Sung Gi Hwang, Changwon-si (KR); Jeung Gie Ahn, Seoul (KR)

Correspondence Address: MCKENNA LONG & ALDRIDGE LLP, 1900 K STREET, NW, WASHINGTON, DC, 20006, US

(21) Appl. No.: 11/024,806

(22) Filed: Dec. 30, 2004

(30) Foreign Application Priority Data
Dec. 30, 2003 (KR) P 2003-100046
Dec. 30, 2003 (KR) P 2003-100045

(51) Int. Cl. F26B 11/02; D06F 21/00

(52) U.S. Cl. 34/603; 68/142

(57) ABSTRACT

Cabinet for a home appliance including a front panel, side panels, and a base, wherein the base includes at least one reinforcing projection at a predetermined portion of the base for improving strength of the base, thereby providing a cabinet for a home appliance having a base with improved strength against load and vibration, to prevent deformation or damage to the base.

### CROSS-REFERENCE TO RELATED APPLICATIONS

This application claims the benefit of Korean Application Nos. P2003-100045, and P2003-100046 both filed on Dec. 30, 2003, which are hereby incorporated by reference as if fully set forth herein.

### BACKGROUND OF THE INVENTION

1. Field of the Invention

The present invention relates to cabinets, exteriors of home appliances, and more particularly, to a cabinet of a home appliance having a reinforced structure.

2. Discussion of the Related Art

In general, the cabinet of a home appliance forms an exterior of a washing machine, or a laundry dryer, and protects various components held therein. A related art laundry dryer having a related art cabinet for a home appliance applied thereto will be described.

In general, the laundry dryer supplies hot air to a drying object, such as washed wet laundry, for drying the drying object. The related art laundry dryer is provided with a cabinet, an exterior of the laundry dryer, and a drum rotatably mounted in the cabinet for holding a drying object.

The cabinet of the laundry dryer is provided with a base, a front panel, a front of the cabinet, having a bottom edge joined to a front edge of the base, side panels joined to opposite edges of the base, to form sides of the cabinet, a rear panel having a bottom edge joined to a rear edge of the base, to form a rear of the cabinet, and a top panel joined to top edges of the front panel, the side panels, and the rear panel, to form a top of the cabinet.

The front panel has a control panel at an upper portion, for operating the laundry dryer, an opening at a center portion for introduction of the drying object, and a door secured to one side of the opening.

The drum is connected to an air supply duct assembly for supplying hot air to an inside of the drum, and an exhaust duct assembly for guiding exhaust air from the drum after drying the drying object, for drying the drying object.

In the meantime, the base supports loads of the front panel, the side panels, the rear panel, and components in the cabinet, such as drum, and so on, and has vibration occurred by rotation of drum transmitted thereto.

Because of this, the base is liable to bend, or deform, so as to seat the laundry dryer on a floor in an unstable state, leading the cabinet to rock in front/rear, or left/right directions during operation of the laundry dryer, to produce noise.

### SUMMARY OF THE INVENTION

Accordingly, the present invention is directed to a cabinet for a home appliance that substantially obviates one or more problems due to limitations and disadvantages of the related art.

An object of the present invention is to provide a cabinet for a home appliance, having a base of which strength is improved for preventing deformation or damage to the base caused by a load or vibration.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cabinet for a home appliance includes a front panel, side panels, and a base, wherein the base includes at least one reinforcing projection at a predetermined portion of the base for improving strength of the base.

The at least one reinforcing projection includes a reinforcing bead at an edge of the base. The reinforcing bead is projected upward.

Alternatively, the at least one reinforcing projection may include a leg mounting portion projected to one side of the base for mounting a leg thereto.

The at least one reinforcing projection may further include a reinforcing beat at an edge of the base, and preferably, the leg mounting portion is formed projected in a direction opposite to a direction of projection of the reinforcing bead.

In more detail, the leg mounting portion is formed projected downward.

Preferably, the base may further include a leg mounting member mounted to the leg mounting portion for improving strength of the base, the leg mounting member having a leg mounting hole passed through in an up/down direction.

The leg mounting member is mounted on an underside of the leg mounting portion, and supports at least one of the front panel, and the side panel.

The leg mounting member includes a fixing projection inserted in a bottom edge of the front panel, for fixing the front panel.

The leg mounting member includes an align member for aligning the leg mounting member with a predetermined position of the base.

The align member includes an align projection to be inserted in a slot in a predetermined position of the base.

The align member may further include a holding projection formed as one body with the align projection for being held at an upper surface of the base.

The leg mounting member may include a leg anti-loosening hole extended from the leg mounting hole in a radial direction, and has one side edge, and the other side edge respectively having heights different from each other.

The leg mounting member may include a supplementary bead for improving strength of the leg mounting member.

In another aspect of the present invention, a cabinet for a home appliance includes a front panel, side panels, and a base, wherein the base includes reinforcing beads at edges of the base for improving strength of the base, and a leg mounting portion projected downward from a corner of the base for mounting a leg thereto.

Preferably, the reinforcing bead is projected upward, and the leg mounting portion is projected downward.

The base further includes a leg mounting member on an underside of the leg mounting portion for improving strength of the base, the leg mounting member having a leg mounting hole passed in an up/down direction.

The leg mounting member includes a front panel supporting portion having a fixing projection inserted in a bottom edge of the front panel, for supporting the front panel.

The leg mounting member may include a side panel supporting portion for supporting the side panel.

The leg mounting member includes an align projection to be inserted in a slot in a predetermined position of the base for aligning the leg mounting member with a predetermined position of the base.

The leg mounting member preferably includes a holding projection formed at a top of the align projection as one body with the align projection, for being held at an upper surface of the base.

The leg mounting member may include a leg anti-loosening hole extended from the leg mounting hole in a radial direction, and has one side edge, and the other side edge respectively having heights different from each other, or a supplementary bead projected downward for improving strength of the leg mounting member.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of a laundry dryer having a cabinet in accordance with a first preferred embodiment of the present invention;

FIG. 2 illustrates a perspective view of a first embodiment base of a cabinet present invention;

FIG. 3 illustrates a section of the base across a line I-I in FIG. 2;

FIG. 4 illustrates a section of the base across a line II-II in FIG. 2;

FIG. 5 illustrates a section of a joint portion of a base and a rear panel;

FIGS. 6A and 6B illustrate the steps of a process for joining a base to a rear panel with Tox round joint;

FIG. 7 illustrates a perspective view of a second embodiment base of a cabinet of the present invention;

FIG. 8 illustrates a perspective view of a corner of an underside of a base having one embodiment of a leg mounting member to be provided to a cabinet of the present invention secured thereto;

FIG. 9 illustrates a perspective view of one embodiment of the leg mounting member in FIG. 8; and

FIG. 10 illustrates an exploded perspective view of the leg mounting member separated from the cabinet in FIG. 9.

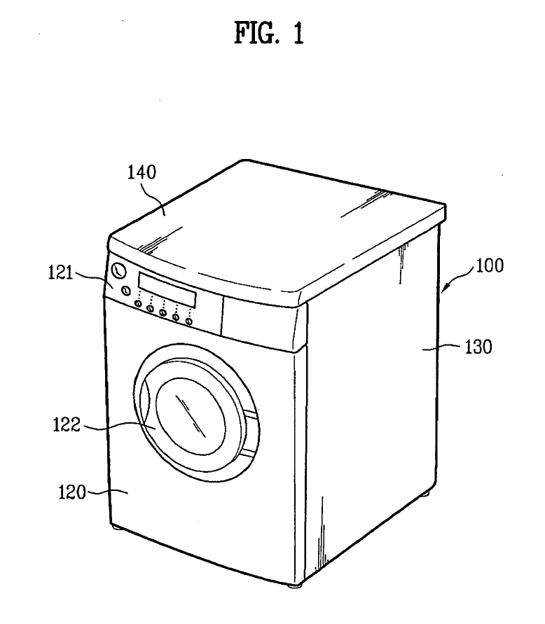

### DETAILED DESCRIPTION OF THE INVENTION

Reference will now be made in detail to the preferred embodiments of the invention, examples of which are illustrated in the accompanying drawings. Whenever possible, the same reference numbers will be used throughout the drawings to refer to the same or like parts.

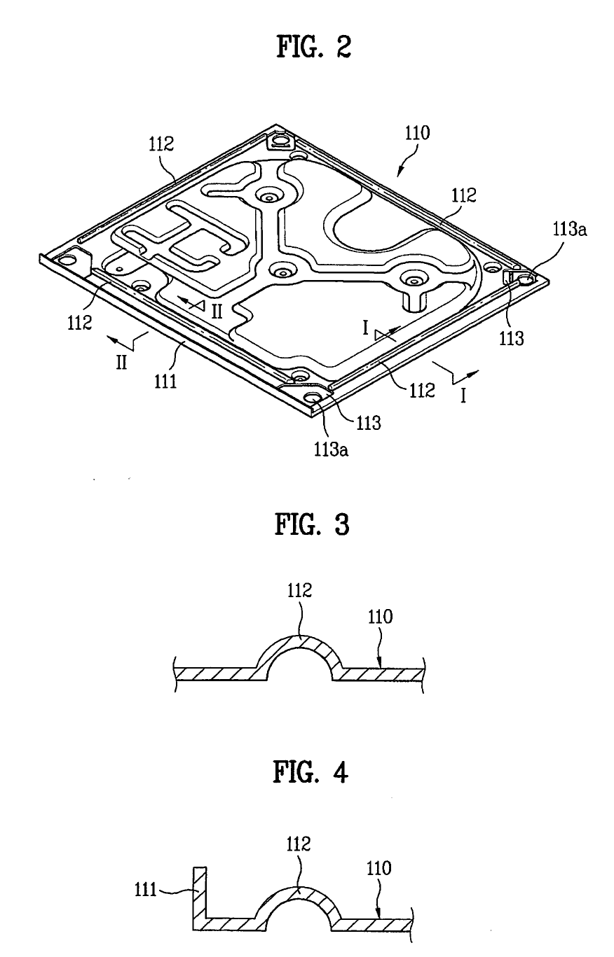

A laundry dryer having a cabinet for a home appliance in accordance with a preferred embodiment of the present invention applied thereto, and a first embodiment base applied to the cabinet will be described, with reference to FIGS. 2 and 3.

Referring to FIGS. 2 and 3, the laundry dryer includes a cabinet 100 forming an exterior of the laundry dryer, and a drum (not shown) in the cabinet for holding a drying object.

The cabinet 100 of the laundry dryer includes a base 110, a front panel 120, a front of the cabinet 100, having a bottom edge joined to a front edge of the base 110, side panels 130 joined to opposite edges of the base 110, to form sides of the cabinet 100, a rear panel not shown) having a bottom edge joined to a rear edge of the base 110, to form a rear of the cabinet, and a top panel 140 joined to top edges of the front panel 120, the side panels, and the rear panel, to form a top of the cabinet 100.

The front panel 120 has a control panel 121 at an upper portion, for operating the laundry dryer, an opening (not shown) at a center portion for introduction of the drying object, such as laundry, and a door 122 rotatably secured to one side of the opening, for opening/closing the opening.

The drum is configured to rotate by a belt connected to a driving motor (not shown) provided to a lower space of the cabinet 100. For this, the drum has a belt groove (not shown) in an outside circumference for placing the belt therein.

The drum is connected to an air exhaust duct assembly for guiding exhaust air from the drum to an outside of the cabinet. In a passage of the exhaust duct assembly, there is a fan for forcing air to flow.

A first embodiment base 110 to be provided to the cabinet for a home appliance, i.e., a cabinet for a laundry dryer, in accordance with a preferred embodiment of the present invention will be described with reference to FIGS. 2 to 4.

FIG. 2 illustrates a perspective view of a first embodiment base of a cabinet of the present invention, FIG. 3 illustrates a section of the base across a line I-I in FIG. 2, and FIG. 4 illustrates a section of the base across a line II-II in FIG. 2.

Referring to FIGS. 2 to 4, the first embodiment base 110 includes at least one reinforcing projection from a predetermined portion of the base 110, for improving a strength of the base. At a front edge of the base 110, there is a flange 111 bent upward of a predetermined height for joining to the front panel 120.

The at least one reinforcing projection includes reinforcing beads 112 at edges of the base 110. If the base is square like the embodiment, the reinforcing beads 112 project upward along the edges of the base 110.

All of the reinforcing beads 112 may be connected to form a square line, or the reinforcing beads 112 may be formed along the edges excluding four corners of the base 110. it is preferable that the reinforcing bead 112 has a round cross section.

Of course, the reinforcing beads 112 may be formed at some of the edges of the base 110, but it is preferable that the bead 112 is formed at every edge of the base 110 extended along the edge for minimizing bending and distortion liable to occur at the base 110.

The reinforcing beads 112 prevent bending or distortion of the base 110 caused by loads on the base 110, when the side panels 130, and the rear panel are joined to the base 110, and various components, such as the drum, are mounted in the cabinet.

Different from this, at least one of the reinforcing projection may include a leg mounting portion 113 projected from one side of the base 110, for mounting a leg 150 for supporting the cabinet 100. It is preferable that the leg mounting portion 113 is provided to every corner of the base 110.

In more detail, the leg mounting portion 113 has one side recessed compared to an adjacent region, and the other side projected compared to an adjacent region. The leg mounting portion 113 has a leg mounting hole 113a for mounting the leg 150.

The leg mounting portion 113 prevents the base 110 from being bent or suffering from damage even if there is a load concentrated on the corner of the base 110 to which the leg 150 is mounted.

Of course, the first embodiment base 110 includes all of the leg mounting portions 113 at corners of the base 110 respectively, and the reinforcing beads 112 extended along the edges of the base 110, respectively.

It is preferable that the reinforcing bead 112 and the leg mounting portion 113 are projected to opposite directions. In more detail, the reinforcing bead 112 is projected upward, and the leg mounting portion 113 is projected downward. In other word, the leg mounting portion 113 is formed to project toward the ground.

The leg mounting portion 113 is projected in a direction opposite to the direction of projection of the reinforcing bead 112, because, if the leg mounting portion 113 is projected in a direction the same with the projection direction of the reinforcing bead 112, there will be wrinkles formed in the base 110.

Accordingly, it is preferable that the leg mounting portion 113 is projected in a direction opposite to the direction of projection of the reinforcing bead 112, for preventing formation of the wrinkles in formation of the base 110.

Of course, the reinforcing bead 112 and the leg mounting portion 113 of the base may be formed by a variety of methods, such as injection molding, or the like.

In the meantime, the base 110 may include a reinforcing rib (not shown) instead of the reinforcing bead 112.

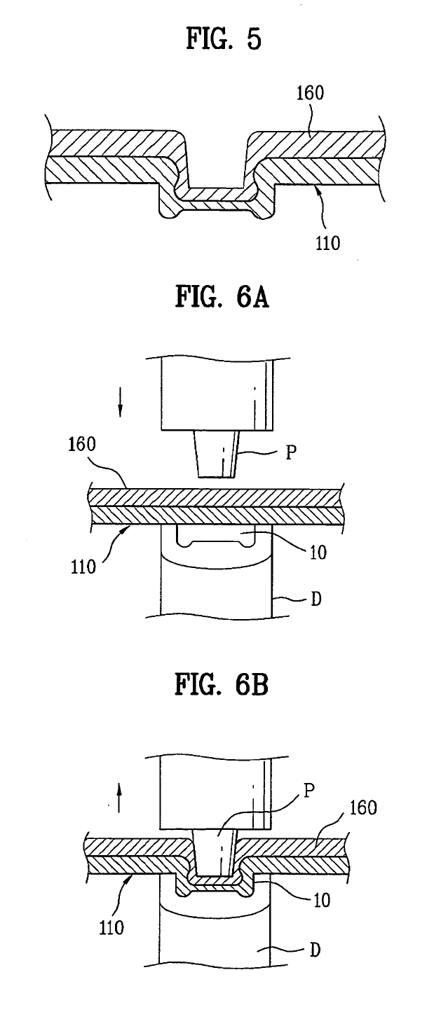

A method for joining the first embodiment base 110 to the rear panel will be described with reference to FIGS. 5, 6A, and 6B.

Referring to FIG. 5, the base 110 is joined to a bottom flange 160 of the rear panel with by a Tox round joint method. The Tox round joint method joins two plates, easily.

The Tox round joint method will be described with reference to FIGS. 6A and 6B. There is press die D having one side provided with a truncated conical press punch P, and the other side provided with a substantially circular recess 10.

The recess 10 in the press die D has a diameter greater than a diameter of the press punch P, with a bottom thereof having an edge lower than a center.

Therefore, after overlapping, and placing two plates 110, and 160, i.e., the bottom flange 160 of the rear panel and the rear edge of the base 110 intended to join on the press die D, if the press punch P presses down the overlapped two plates 110, and 160 toward the press die D, the two plates 110, and 160 are pushed into the recess 10 of the press die D, and joined together.

The Tox round joint method is applicable to joining of the side panel 130 to the base 110, and joining of the side panel 130 to the rear panel.

Of course, though the rear panel can be join to the base 110 by other methods, such as screw fastening, or curling of plates, because the Tox round joint method is simple, and requires components less than other joining methods, the Tox round joint method can shorten an assembly time period of the cabinet 100, and prevents the problem of accumulation of tolerances that occurs in fabrication of components.

In the meantime, the base 110 of the cabinet of the present invention does not require to include all of the reinforcing beads 112, and the leg mounting portions 113, necessarily.

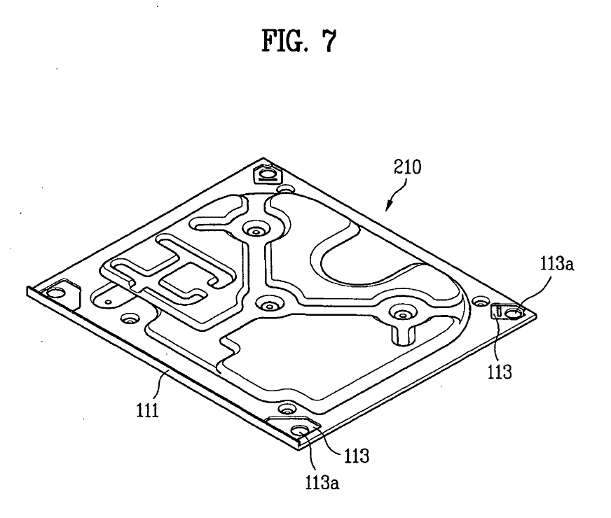

FIG. 7 illustrates a perspective view of a second embodiment base of a cabinet of the present invention. The second embodiment base 210 includes no reinforcing beads 112 at the edges, and other parts identical to the part of the first embodiment base 210, of which description will be omitted.

Alike the foregoing embodiments, the base 210 may have the reinforcing beads 112 and/or the leg mounting portions 113 for improving strength, for preventing bending and distortion of the base 210.

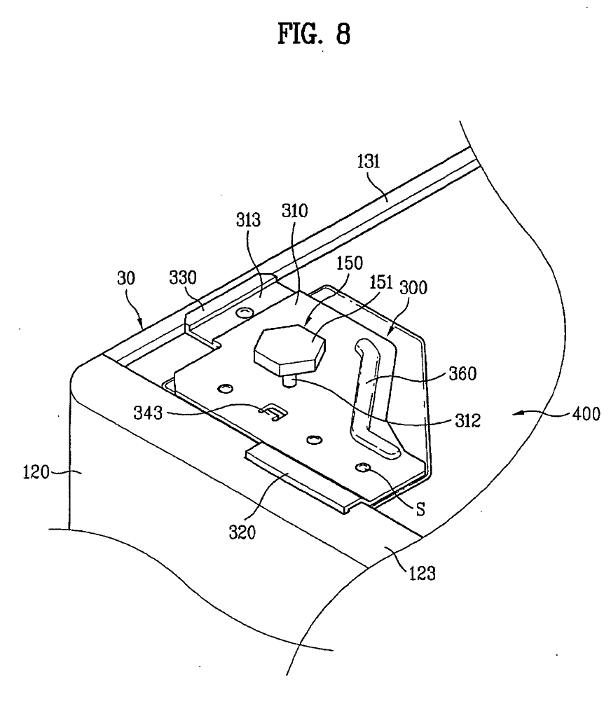

Next, a third embodiment base of a cabinet for a home appliance, having a leg mounting member 300 of the present invention will be described, with reference to FIGS. 8 to 10.

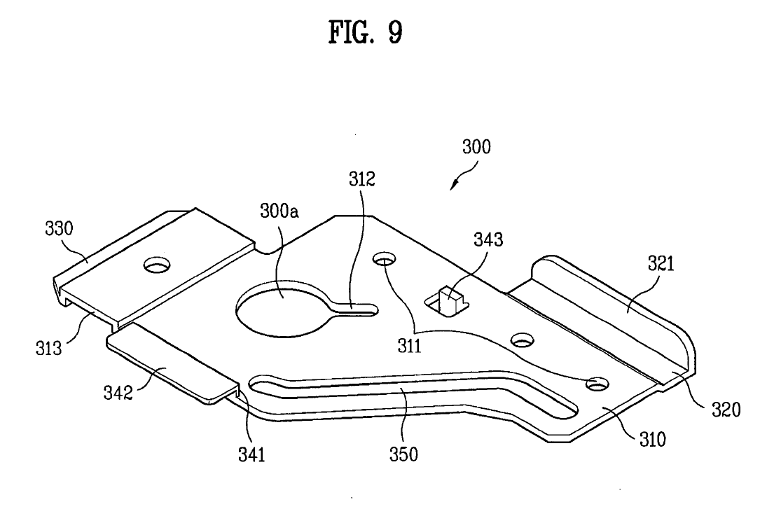

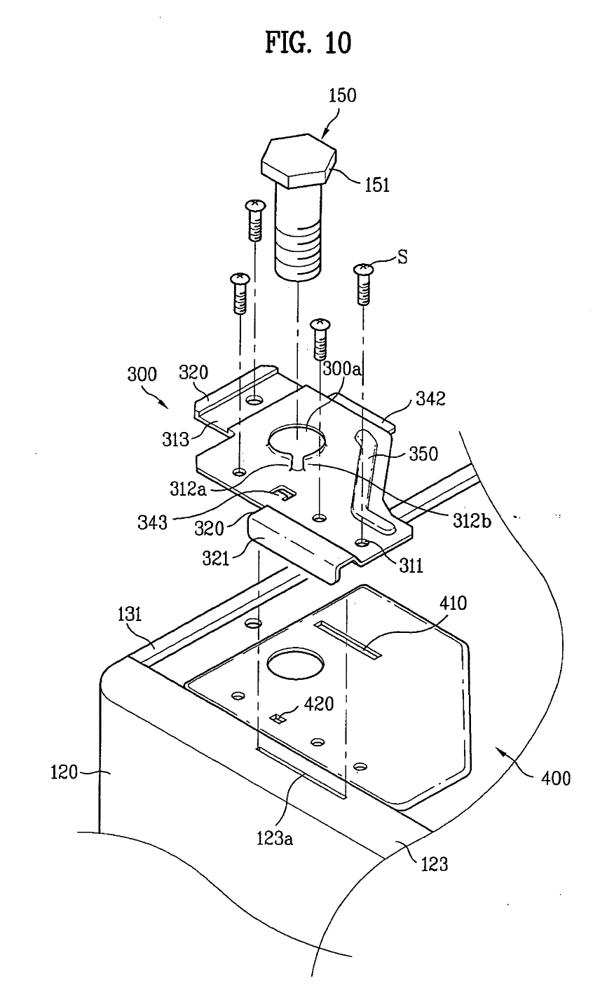

FIG. 8 illustrates a perspective view of a corner of an underside of a base having one embodiment of a leg mounting member to be provided to a cabinet of the present invention secured thereto, FIG .9 illustrates a perspective view of one embodiment of the leg mounting member in FIG. 8, and FIG. 10 illustrates an exploded perspective view of the leg mounting member separated from the cabinet in FIG. 9.

Referring to FIG. 8 to 10, the leg mounting member 300 is provided to the third embodiment base 400 for preventing deformation of the base 400. The leg mounting member 300 may be joined to the leg mounting portion described in the different embodiment of bases 110, and 210.

Alike the leg mounting portion 113 at each of the corners of the base 110 or 210 in the first, or second embodiment, though it is preferable that the third embodiment base 400 includes the leg mounting portion projected downward, the projections like the bases 110 and 210 of the first and second embodiments are not required, necessarily.

In describing the third embodiment base 400, parts identical to the parts of the first, or second base 110, or 210 will be given the same reference symbols, and repetitive description of which will be omitted.

The leg mounting member 300 is mounted on an underside of the leg mounting portion 113, for supporting the base 400, and has a leg mounting hole 300a passed through the leg mounting member 300 in correspondence to the leg mounting hole 113a.

It is preferable that the leg mounting member 300 is configured to support at least one of the front panel 120 or the side panel 130.

In the embodiment, the leg mounting member 300 has one side for supporting the front panel 120, and the other side for supporting the side panel 130.

For this, at the bottom edge of the side panel 130 that forms a side of the cabinet 100, there is a flange 131 bent inward vertically, and at the bottom edge of the front panel 120 that forms a front of the cabinet 100, there is a flange 123 bent backward.

The leg mounting member 300 is mounted at each of front opposite corners of the base 400, but the mounting positions are not limited to these.

The leg mounting member 300 will be described; in more detail. The leg mounting member 300 includes a base supporting portion 310 joined to the leg mounting portion for supporting the base 400, a front panel supporting portion 320 for supporting the front panel 120, and a side panel supporting portion 330 for supporting the side panel 130.

The base supporting portion 310 has the leg mounting hole 330a, and a plurality of screw fastening holes 311 in the vicinity of the leg mounting hole 330a, particularly in a front portion of the base supporting portion 310 for fastening the leg mounting member 300 to the base 110 with screws S.

It is preferable that the base supporting portion 310 further has a leg anti-loosening hole 312 for preventing the leg from loosening.

The leg anti-loosening hole 312 is extended from the leg mounting hole 330a in a radial direction, and has one side edge 312a, and the other side edge 312b respectively having heights different from each other, so as to serve as a washer.

According to this, once the leg 150 is mounted, a head 151 of the leg is brought into contact with the opposite edges 312a and 312b of the leg anti-loosening hole 312, thereby preventing the leg 150 from loosening.

The front panel supporting portion 320, at a front of the leg mounting member 300, supports the lower edge of the front panel 120, i.e., the flange 123 of the front panel.

At a front edge of the front panel supporting portion 320, there is a fixing projection 321 bent upward from the front edge, for inserting in a fixing slot 123a in the flange 123 of the front panel, for fixing the bottom edge of the front panel 120.

The front panel supporting portion 320 enables an easy joining of the front panel 120, as well as supports a portion of a load of the front panel 120, to reduce the load on the base 400.

Next, the side panel supporting portion 330, at a side of the leg mounting member, for supporting a bottom edge of the side panel 130, i.e., the flange 131 of the side panel.

In the meantime, referring to FIGS. 8 and 10, in a case the bottom edges of the front panel 120 and the side panel 130 are lower than the bottom of the base 400, particularly, a bottom of the leg mounting portion 113, the front panel supporting portion 320 and the side panel supporting portion 330 are stepped so as to be lower than the base supporting portion 310.

Particularly, if the leg mounting portion is projected downward to a predetermined height, a supplementary supporting portion 313 may be formed projected to form a step higher than the base supporting portion 310, between the base supporting portion 310 and the side panel supporting portion 330.

In addition to this, the leg mounting member 300 further includes an align member for aligning the leg mounting member 300 with a predetermined position of the base 400.

The align member includes an align projection 341 bent upward from a rear edge of the base supporting portion 310 for inserting in an align slot 410 in a predetermined position of the base 400.

The align member may further include a holding projection 342 formed as one body at a top of the align projection 341 for being held at an upper surface of the base.

The holding projection 342 is perpendicular to the align projection 341, and parallel to the base supporting portion 310.

Accordingly, the holding projection 342 passes the align slot 410 before the align projection 341 in a process the leg mounting member 300 is joined to the leg mounting portion of the base 400, and is held at the upper surface of the base 400 as an upper surface of the base supporting portion 310 is brought into close contact with the underside of the leg mounting portion, to prevent the leg mounting member 300 from loose, and to enable easy fastening of the screws S.

It is preferable that the align member further includes a supplementary align projection 343 projected upward from the base supporting portion 310.

The supplementary align projection 343 is inserted in a supplementary align hole 420 in the leg mounting portion, for aligning a position of the leg mounting member 300, and making mounting of the leg mounting member 300 easy.

Of course, the align member may include one of the align projection 341 and the supplementary align projection 343.

In the meantime, in order to improve strength of the leg mounting member 300, the leg mounting member 300 may further include a supplementary bead 350 on the base supporting portion 310. It is preferable that the supplementary bead 350 is projected downward such that the leg mounting member 300 and the leg mounting portion are brought into close contact.

A process for assembling the cabinet for a home appliance, i.e., a cabinet for a laundry dryer, will be described.

After joining the side panel 130 to the base 400, the leg mounting member 300 is attached to the leg mounting portion of the base 400.

A process for assembling the leg mounting member 300 and the base 400 will be described in more detail.

At first, upon inserting the holding projection 342 and the align projection 341 on the leg mounting member 300 in the align slot in the base, and inserting the supplementary align projection in the supplementary align hole 420, the leg mounting member 300 is properly positioned, without loosening of the leg mounting member 300.

Then, screws S are fastened to the screw holes 311, to fixedly secure the leg mounting member 300 to the leg mounting portion of the base 400. According to this, the side panel supporting portion 330 of the leg mounting member 300 supports the flange 131 at the bottom edge of the side panel.

After completion of assembly of the base 400 and the leg mounting member 300, for joining the front panel 120 to a front of the cabinet 100, the fixing projection 321 on the front panel supporting portion is inserted in the fixing slot in the flange 123 of the front panel, falling off of the bottom edge of the front panel is prevented, and a portion of load of the front panel 120 is supported on the leg mounting member 300. Then, the front panel 120 is fastened to the front of the cabinet with fastening devices, such as screws (not shown) or hooks (not shown).

The operation of the laundry dryer of the present invention, having a cabinet with the foregoing base will be described.

Upon putting a drying object, such as clothes, in a drum through the opening in the cabinet 100, and closing the door 122, the laundry dryer is put into operation by using the control panel 121.

According to this, when the fan in the exhaust duct assembly rotates to draw air, external air is drawn into the cabinet 100 through the rear panel, heated by the heater, and introduced into the drum through the air supply duct assembly.

In this instance, for drying the drying object, the drum is rotated by the driving motor and the belt, the hot air introduced into the rotating drum extracts moisture from the drying object, and carries away through the exhaust duct.

The cabinet for a home appliance of the present invention has the following advantages.

First, the reinforcing projections from the base prevents the base from bending or distortion.

Second, the joining of the side panel and the rear panel to the base with Tox round joint makes assembly of the cabinet easy, and reduces a number of components.

Third, the leg mounting member mounted to the base prevents the base from deformation.

Fourth, the leg mounting member mounted to the base that can support loads of the front panel and the side panel prevents the base from deformation caused by a load from an upper side.

Fifth, the fixing projection on the leg mounting member enables easy joining of the front panel.

Sixth, the align member on the leg mounting member makes joining of the leg mounting member easy.

Seventh, the reinforcing bead on the leg mounting member for improving strength permits to prevent deformation of the leg mounting member and the base.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A cabinet for a home appliance comprising:
a front panel;
side panels; and
a base,
wherein the base includes at least one reinforcing projection at a predetermined portion of the base for improving strength of the base.

2. The cabinet as claimed in claim 1, wherein the at least one reinforcing projection includes a reinforcing bead at an edge of the base.

3. The cabinet as claimed in claim 2, wherein the reinforcing bead is projected upward.

4. The cabinet as claimed in claim 1, wherein the at least one reinforcing projection includes;
a leg mounting portion projected to one side of the base for mounting a leg thereto.

5. The cabinet as claimed in claim 4, wherein the at least one reinforcing projection further includes a reinforcing bead at an edge of the base, and
the leg mounting portion is formed projected in a direction opposite to a direction of projection of the reinforcing bead.

6. The cabinet as claimed in claim 4, wherein the leg mounting portion is formed projected downward.

7. The cabinet as claimed in claim 1, wherein the base further includes a leg mounting member mounted to the leg mounting portion for improving strength of the base, the leg mounting member having a leg mounting hole passed through in an up/down direction.

8. The cabinet as claimed in claim 7, wherein the leg mounting member is mounted on an underside of the leg mounting portion, and supports at least one of the front panel, and the side panel.

9. The cabinet as claimed in claim 8, wherein the leg .mounting member includes a fixing projection inserted in a bottom edge of the front panel, for fixing the front panel.

10. The cabinet as claimed in claim 7, wherein the leg mounting member includes an align member for aligning the leg mounting member with a predetermined position of the base.

11. The cabinet as claimed in claim 10, wherein the align member includes an align projection to be inserted in a slot in a predetermined position of the base.

12. The cabinet as claimed in claim 11, wherein the align member further includes a holding projection formed as one body with the align projection for being held at an upper surface of the base.

13. The cabinet as claimed in claim 7, wherein the leg mounting member includes a leg anti-loosening hole extended from the leg mounting hole in a radial direction, and has one side edge, and the other side edge respectively having heights different from each other.

14. The cabinet as claimed in claim 7, wherein the leg mounting member includes a supplementary bead for improving strength of the leg mounting member.

15. A cabinet for a home appliance comprising:
a front panel;
side panels; and
a base,
wherein the base includes;
reinforcing beads at edges of the base for improving strength of the base, and
a leg mounting portion projected downward from a corner of the base for mounting a leg thereto.

16. The cabinet as claimed in claim 15, wherein the reinforcing bead is projected upward, and the leg mounting portion is projected downward.

17. The cabinet as claimed in claim 16, wherein the base further includes a leg mounting member on an underside of the leg mounting portion for improving strength of the base, the leg mounting member having a leg mounting hole passed in an up/down direction.

18. The cabinet as claimed in claim 17, wherein the leg mounting member includes a front panel supporting portion having a fixing projection inserted in a bottom edge of the front panel, for supporting the front panel.

19. The cabinet as claimed in claim 17, wherein the leg mounting member includes a side panel supporting portion for supporting the side panel.

20. The cabinet as claimed in claim 17, wherein the leg mounting member includes an align projection to be inserted in a slot in a predetermined position of the base for aligning the leg mounting member with a predetermined position of the base.

21. The cabinet as claimed in claim 17, wherein the leg mounting member includes a holding projection formed at a top of the align projection as one body with the align projection, for being held at an upper surface of the base.

22. The cabinet as claimed in claim 17, wherein the leg mounting member includes a leg anti-loosening hole extended from the leg mounting hole in a radial direction, and has one side edge, and the other side edge respectively having heights different from each other.

23. The cabinet as claimed in claim 17, wherein the leg mounting member includes a supplementary bead projected downward for improving strength of the leg mounting member.
